(19) United States
(12) Patent Application Publication
(10) Pub. No.: US 2012/0194009 A1
(43) Pub. Date: Aug. 2, 2012

(54) Motor and Motor Assembling Method

(76) Inventor: Alex Horng, Kaohsiung (TW)

(21) Appl. No.: 13/052,423

(22) Filed: Mar. 21, 2011

(30) Foreign Application Priority Data
Feb. 1, 2011 (TW) 100103819

(51) Int. Cl. H02K 5/167; H02K 15/00

(52) U.S. Cl. 310/43; 29/596

(57) ABSTRACT

A motor assembling method is disclosed. The motor assembling method provides a base with a shaft tube, wherein the shaft tube has a thermoplastic positioning portion on an opening end thereof, and a shaft tube assembly is disposed into the shaft tube via the opening end. The motor assembling method further heats the thermoplastic positioning portion by a heating fixture to melt and deform the thermoplastic positioning portion until the opening end of the shaft tube has shrunk, wherein the shaft tube assembly is held in position in the shaft tube after the thermoplastic positioning portion has cooled down and solidified. The motor assembling method further couples a stator unit with an outer circumferential wall of the shaft tube, and couples a rotor with the shaft tube.

### BACKGROUND OF THE INVENTION

1. Field of the Invention

The present invention generally relates to a motor and a motor assembling method and, more particularly, to a motor and a motor assembling method that can securely hold components received in the motor's shaft tube in position.

2. Description of the Related Art

Referring to FIG. 1, a cooling fan is disclosed by Taiwanese Patent No. I287962. During assembly of the cooling fan 8, four standing bars 811 of a shaft sleeve 81 that are flexible and radially arranged are bent outwards to receive a bearing 82. After the bearing 82 is received in a compartment defined by the four standing bars 811, the four standing bars 811 are released to fix the bearing 82 in the compartment. Accordingly, subsequent assembly procedures can be performed.

In the conventional motor assembling method above, the four standing bars 811 may not be able to clip the bearing 82 in a stable way even though they encase the bearing 82. In light of this, additional components are required to better fix the bearing 82. In addition, a gap is presented between each two adjacent standing bars 811 and that gap may result in weak structural strength of the shaft sleeve 81, which shortens the service life of the cooling fan 8. More importantly, the cooling fan 8 has an inconvenient assembly as it is required to bend the four standing bars 811 outwards when receiving the bearing 82.

Referring to FIG. 2, a stator of a conventional motor 9 is disclosed by Taiwanese Patent Publication No. 201041279 entitled “the motor stator”. During assembly of the conventional motor 9, it is required to dispose a bearing 91 and a supporting member 92 in a shaft tube 93 first (components that are intended to be received in the shaft tube 93 are called “shaft tube assembly” hereinafter, such as the bearing 91 and supporting member 92 in this case). Then, a stator 94 is fitted around the shaft tube 93. Finally, a position fixing member 941 can be provided to abut against the shaft tube assembly. Based on this, subsequent assembly procedures can be performed.

However, the position fixing member 941 of the stator 94 requires independent manufacture, which increases the structural complexity and costs of the stator 94. Furthermore, since it is somewhat difficult for one to control his force applied for assembling the conventional motor 9, the position fixing member 941 of the stator 94 may cleave or snap off easily when the position fixing member 941 does not press the shaft tube assembly with a proper force. This not only causes inconvenience in assembly but also affects the positioning efficiency of the shaft tube assembly.

In light of this, it is desired to improve the positioning structure of the shaft tube assembly.

### SUMMARY OF THE INVENTION

It is therefore the primary objective of this invention to provide a motor assembling method which uses a shaft tube of a motor to hold a shaft tube assembly received in the shaft tube in position, thereby simplifying the assembly procedures of the motor.

It is another objective of this invention to provide a motor assembling method which prevents a shaft tube assembly received in a shaft tube from being excessively pressed by the shaft tube.

It is yet another objective of this invention to provide a motor assembling method which can efficiently hold a shaft tube assembly received in a shaft tube in position without using additional components, thereby preventing other components from being damaged during assembly procedures.

It is yet another objective of this invention to provide a motor which uses a shaft tube to hold a shaft tube assembly received in the shaft tube in position, thereby preventing the shaft tube assembly from disengaging from the shaft tube.

It is yet another objective of this invention to provide a motor which provides a simplified structure for holding a shaft tube assembly received in a shaft tube of the motor in position, thereby efficiently reducing the manufacturing costs and structural complexity of the motor.

The invention discloses a motor assembling method. The motor assembling method provides a base with a shaft tube, wherein the shaft tube has a thermoplastic positioning portion on an opening end thereof, and a shaft tube assembly is disposed into the shaft tube via the opening end. The motor assembling method further heats the thermoplastic positioning portion by a heating fixture to melt and deform the thermoplastic positioning portion until the opening end of the shaft tube has shrunk, wherein the shaft tube assembly is held in position in the shaft tube after the thermoplastic positioning portion has cooled down and solidified. The motor assembling method further couples a stator unit with an outer circumferential wall of the shaft tube, and couples a rotor with the shaft tube.

Furthermore, the invention discloses a motor. The motor includes a base having a shaft tube receiving a shaft tube assembly, wherein the shaft tube assembly has a maximal outer diameter, the shaft tube has a thermoplastic positioning portion on an opening end thereof, the opening end of the shaft tube has shrunk into a smaller opening end having a minimal inner diameter when the thermoplastic positioning portion deforms, the minimal inner diameter is smaller than the maximal outer diameter of the shaft tube assembly, a stator unit is coupled with an outer circumferential wall of the shaft tube, and the shaft tube is coupled with a rotor.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an exploded diagram of a conventional cooling fan.

FIG. 2 shows a side cross-sectional diagram of a conventional motor.

FIG. 3 shows a flowchart of a motor assembling method according to a preferred embodiment of the invention.

FIG. 4 shows a diagram of a pre-assembling step of the motor assembling method according to the preferred embodiment of the invention.

FIG. 5 shows a diagram of an assembling and positioning step of the motor assembling method according to the preferred embodiment of the invention.

FIG. 6 shows another diagram of the assembling and positioning step of the motor assembling method according to the preferred embodiment of the invention.

FIG. 7 shows a diagram of a final assembling step of the motor assembling method according to the preferred embodiment of the invention.

FIG. 8 shows a side cross-sectional diagram of a motor of the invention.

FIG. 9 shows a diagram of a motor base of the invention.

FIG. 10 shows a side cross-sectional diagram of another motor of the invention.

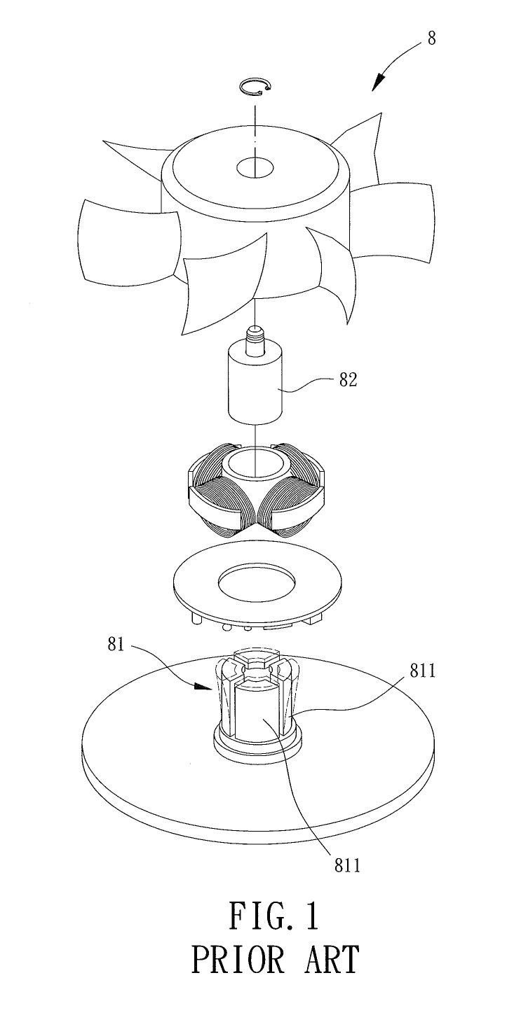

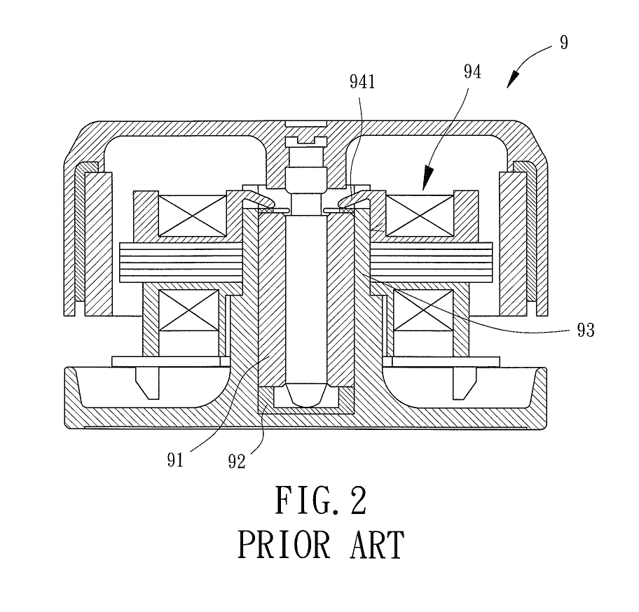

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

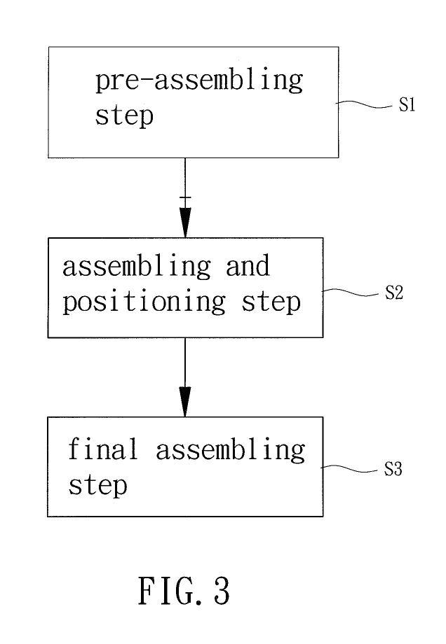

Referring to FIG. 3, the motor assembling method of the invention comprises a pre-assembling step S1, an assembling and positioning step S2 and a final assembling step S3.

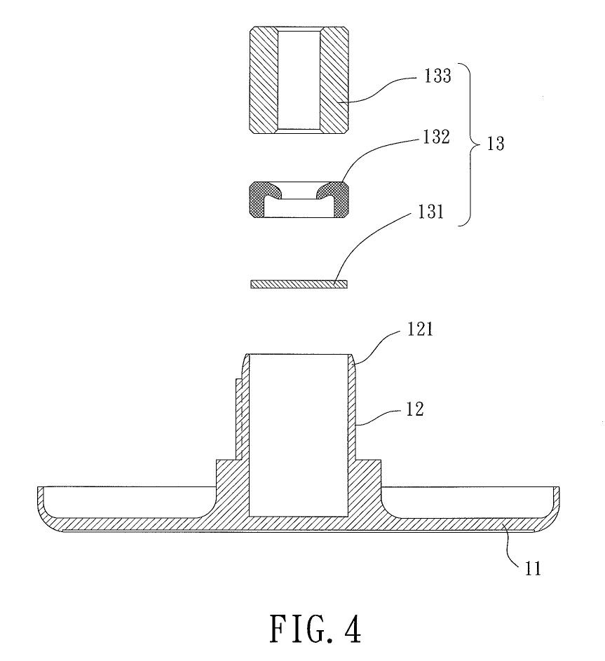

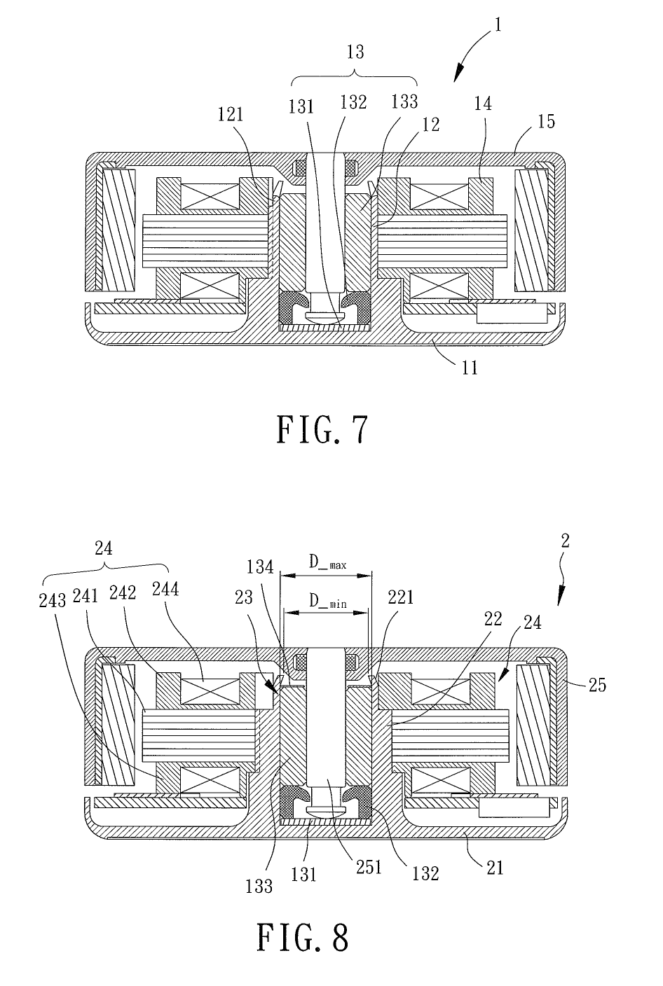

Referring to FIGS. 3 and 4, the pre-assembling step S1 is to provide a base 11 with a shaft tube 12, with the shaft tube 12 having a thermoplastic positioning portion 121 on an opening end thereof. Here, it is defined that components that are intended to be received in the shaft tube 12 are called “shaft tube assembly 13”, which is used in the entire specification hereinafter. The shaft tube assembly 13 consists of at least one of the components that can be received in the shaft tube 12 and can provide various functions for a motor 1 (shown in FIG. 7), such as a wear-resisting plate 131, a holding member 132, a bearing 133, a dust-proof plate 134, an oil seal and a positioning member (the functions of these components are well-known in this art, so they are not described herein again), as shown in FIGS. 8 and 10. In this embodiment, the shaft tube 12 is made of thermoplastic material, and the shaft tube assembly 13 includes the wear-resisting plate 131, holding member 132 and bearing 133 disposed in the shaft tube 12 in order.

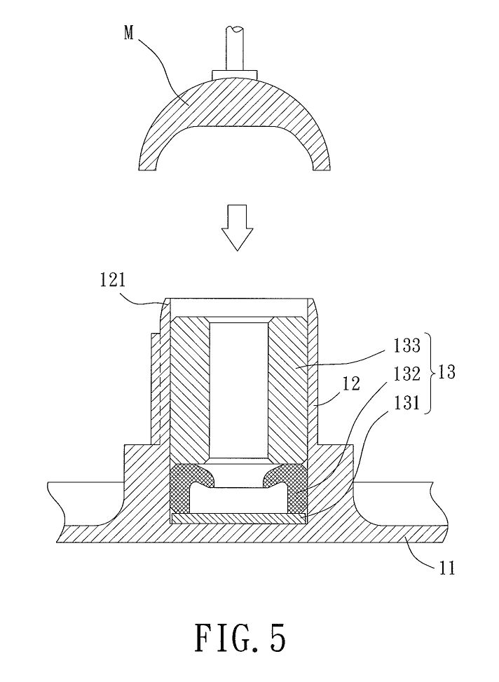

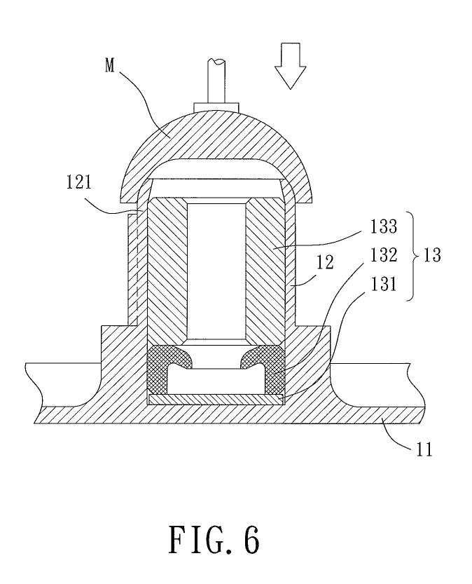

As shown in FIGS. 3 and 5, the assembling and positioning step S2 is to provide a heating fixture M. The heating fixture M is used to press the thermoplastic positioning portion 121 so that the thermoplastic positioning portion 121 can be heated by heating the heating fixture M. As shown in FIG. 6, the thermoplastic positioning portion 121 becomes melted and deformed by heating the heating fixture M (one skilled in this art may readily appreciate that factors that determine melting of the thermoplastic positioning portion 121, such as heating temperature and heating time period, depend on the material condition of the thermoplastic positioning portion 121, so it is not described herein). Therefore, an inner diameter of an opening end of the shaft tube 12 can be reduced by heating up the thermoplastic positioning portion 121. After the opening end of the shaft tube 12 has shrunk, the heating fixture M can be removed from the thermoplastic positioning portion 121. By the time the thermoplastic positioning portion 121 has cooled down and solidified, the shaft tube assembly 13 can be securely positioned in the shaft tube 12, thereby preventing the shaft tube assembly 13 from disengaging from the shaft tube 12.

Referring to FIGS. 3 and 7, the final assembling step S3 is to couple a stator unit 14 with an outer circumferential wall of the shaft tube 12, and to rotatably couple a rotor 15 with the shaft tube 12. In this embodiment, the rotor 15 is rotatably coupled with the shaft tube assembly 13 disposed in the shaft tube 12. In this way, the rotor 15 can couple with the shaft tube 12 via the shaft tube assembly 13, thus completing the assembly procedure of the motor 1.

Based on the motor assembling method above, the invention can achieve at least the following advantages described below.

First, since the thermoplastic positioning portion 121 gets melted and deformed under the heating of the heating fixture M during the assembling and positioning step S2, the opening end of the shaft tube 12 will shrink after the thermoplastic positioning portion 121 has cooled down and solidified. Thus, as one advantage of the invention, the shrunk opening end of the shaft tube 12 may efficiently hold the shaft tube assembly 13 in the shaft tube 12 in position and prevent the disengagement of the shaft tube assembly 13. This simplifies the assembly procedures of the motor 1.

Second, as another advantage of the invention, the motor assembling method of the invention ensures that the shaft tube assembly 13 can be pressed and positioned in the shaft tube 12 in a proper way, preventing the loosening or disengagement of the shaft tube assembly 13.

Third, the thermoplastic positioning portion 121 may serve the purpose of positioning the shaft tube assembly 13 during the assembling and positioning step S2 after the shaft tube 12 has cooled down and solidified. Thus, as another advantage of the invention, the motor assembling method of the invention allows the shaft tube assembly 13 to be pressed simply by the thermoplastic positioning portion 121 without using additional components such as the stator unit 14. This prevents other components from being damaged during assembly procedures of the motor 1.

Referring to FIG. 8, based on the same concept of the motor assembling method above, a motor 2 assembled using the motor assembling method of the invention includes a base 21 having a shaft tube 22, with the shaft tube 22 receiving shaft tube assembly 23 (similar to the shaft tube assembly 13). The shaft tube assembly 23 has a maximal outer diameter D_max. The shaft tube 22 has a thermoplastic positioning portion 221 on an opening end thereof which is away from the base 21. The thermoplastic positioning portion 221 forces the opening end of the shaft tube 22 to shrink into a smaller opening end having a minimal inner diameter D_min, wherein the minimal inner diameter D_min is designed to be smaller than the maximal outer diameter D_max in order to keep the shaft tube assembly 23 in the shaft tube 22. The thermoplastic positioning portion 221 can be of any structure that gets melted and deformed under heating operation. The minimal inner diameter D_min is the size of the shrunk opening end of the shaft tube 22 after the thermoplastic positioning portion 221 has cooled down and solidified from the heating operation.

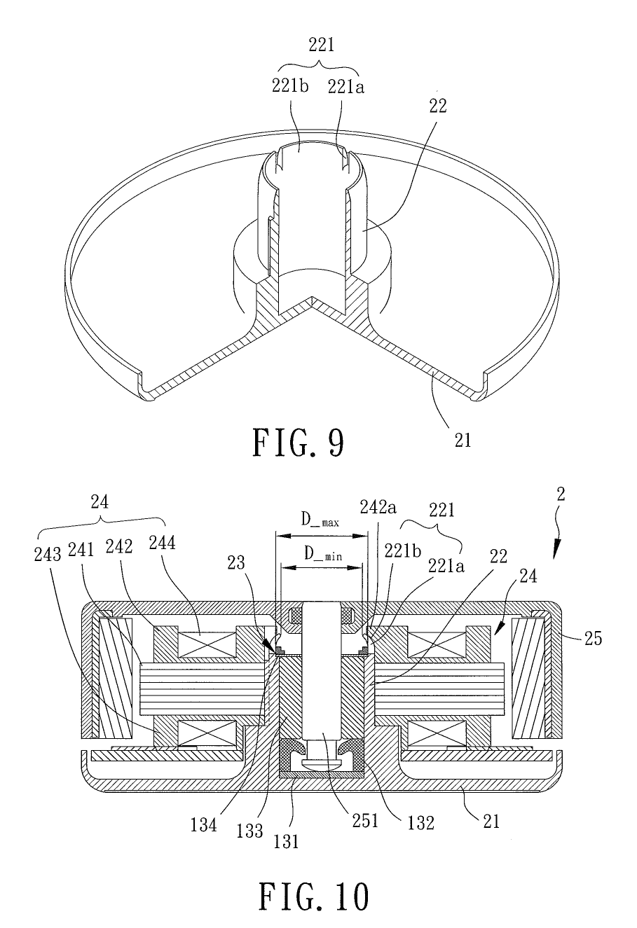

In the embodiment, as shown in FIG. 9, the thermoplastic positioning portion 221 is shown to include a plurality of grooves 221a extending from an outer circumferential wall to an inner circumferential wall of the shaft tube 22, with a position-fixing plate 221b formed between two adjacent grooves 221a. Based on the grooves 221a, when the heating fixture M presses the thermoplastic positioning portion 221, the position-fixing plates 221b can be bent inwards more easily, thus forming the shrunk opening end of the shaft tube 22.

A stator unit 24 may be further coupled with the outer circumferential wall of the shaft tube 22, with the shaft tube 22 coupled with a rotor 25. The stator unit 24 can be of any structure capable of driving the rotor 25 to rotate. The rotor 25 has a shaft 251 rotatably coupled with the shaft tube assembly 23, allowing the rotor 25 to couple with the shaft tube 22 via the shaft 251 and shaft tube assembly 23.

Furthermore, referring to FIG. 10, the stator unit 24 may consist of a plurality of silicon steel plates 241, an upper insulation sleeve 242, a lower insulation sleeve 243 and a coil 244. The silicon steel plates 241, upper insulation sleeve 242 and lower insulation sleeve 243 are stacked to form an insulated silicon steel plate entity, with an enameled wire wound around a predetermined portion of the insulated silicon steel plate entity to form the coil 244. In this arrangement, the upper insulation sleeve 242 may form a pressing portion 242a pressing the thermoplastic positioning portion 221. In this way, the upper insulation sleeve 242 and the thermoplastic positioning portion 221 can jointly provide an enhanced positioning effect for the shaft tube assembly 23.

The motor of the invention has achieved at least the following advantage below. For example, since the opening end of the shaft tube 22 can shrink and the minimal inner diameter D_min is designed to be smaller than the maximal inner diameter D_max, the invention can keep the shaft tube assembly 23 in the shaft tube 22 and prevent the shaft tube assembly 23 from disengaging from the shaft tube 22. Therefore, the invention achieves the cost reduction and reduces overall structural complexity of a motor.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor assembling method, comprising:
providing a base with a shaft tube, wherein the shaft tube has a thermoplastic positioning portion on an opening end thereof, and a shaft tube assembly is disposed into the shaft tube via the opening end;
heating the thermoplastic positioning portion by a heating fixture to melt and deform the thermoplastic positioning portion until the opening end of the shaft tube has shrunk, wherein the shaft tube assembly is held in position in the shaft tube after the thermoplastic positioning portion has cooled down and solidified; and
coupling a stator unit with an outer circumferential wall of the shaft tube and coupling a rotor with the shaft tube.

2. The motor assembling method as claimed in claim 1, wherein the heating fixture presses the thermoplastic positioning portion and then heats the thermoplastic positioning portion.

3. The motor assembling method as claimed in claim 1, wherein the shaft tube is made of thermoplastic material.

4. The motor assembling method as claimed in claim 1, wherein disposing the shaft tube assembly into the shaft tube includes a step of inserting a wear-resisting plate, a holding member and a bearing of the shaft tube assembly into the shaft tube in order.

5. The motor assembling method as claimed in claim 1, wherein coupling the rotor with the shaft tube includes a step of rotatably coupling the rotor with the shaft tube assembly disposed in the shaft tube.

6. A motor including a base having a shaft tube receiving a shaft tube assembly, wherein the shaft tube assembly has a maximal outer diameter, the shaft tube has a thermoplastic positioning portion on an opening end thereof, the opening end of the shaft tube has shrunk into a smaller opening end having a minimal inner diameter when the thermoplastic positioning portion deforms, the minimal inner diameter is smaller than the maximal outer diameter of the shaft tube assembly, a stator unit is coupled with an outer circumferential wall of the shaft tube, and the shaft tube is coupled with a rotor.

7. The motor as claimed in claim 6, wherein the thermoplastic positioning portion is in the form of a plurality of grooves extending from an outer circumferential wall to an inner circumferential wall of the shaft tube, and a position-fixing plate is formed between adjacent two of the plurality of grooves.

8. The motor as claimed in claim 6, wherein the stator unit has a pressing portion pressing the thermoplastic positioning portion.

9. The motor as claimed in claim 8, wherein the stator unit includes a plurality of silicon steel plates, an upper insulation sleeve, a lower insulation sleeve and a coil, wherein the silicon steel plates, the upper insulation sleeve and the lower insulation sleeve are stacked to form an insulated silicon steel plate entity, an enameled wire is wound around a predetermined portion of the insulated silicon steel plate entity to form the coil, and the pressing portion is located on the upper insulation sleeve.

10. The motor as claimed in claim 6, wherein the shaft tube assembly includes at least one of a bearing, a holding member, a dust-proof plate, an oil seal, a positioning member and a wear-resisting plate.
